(19) United States
(12) Patent Application Publication
(10) Pub. No.: US 2004/0043143 A1
(43) Pub. Date: Mar. 4, 2004

(54) Mechanical deposition process

(76) Inventor: Thomas H. Rochester, Jackson, MI (US)

Correspondence Address: Christopher A. Mitchell, YOUNG & BASILE, P.C., 3001 West Big Beaver Road, Suite 624, Troy, MI, 48084-3107, US

(21) Appl. No.: 10/231,576

(22) Filed: Aug. 30, 2002

(51) Int. Cl. B05D 1/12; B05D 1/36; B05D 1/18

(52) U.S. Cl. 427/180; 427/404; 427/436; 427/437

(57) ABSTRACT

The specification discloses a mechanical deposition process for depositing a metal powder on a metal substrate to form a sacrificial coating therefor, wherein the metal powder is produced from a molecular alloy of zinc and aluminum, for instance by the atomization of a molten alloy of zinc and aluminum. The mechanical deposition process described herein is carried out in the presence of a ductile metal more noble than zinc, an activating anion containing a fluoride moiety, and either a fluoride-engendering acidic compound or a weak organic acid.

### FIELD OF THE INVENTION

The present invention relates to mechanical deposition processes, such as are employed to provide a sacrificial coating for metal parts, for example nails, washers, screws, etc., and more particularly to mechanical processes for depositing on a metallic substrate a metal powder produced from a molecular alloy of zinc and aluminum, for instance by the atomization of a molten alloy of zinc and aluminum.

### BACKGROUND OF THE INVENTION

It has long been known to be beneficial to provide metal substrates, for example steel parts such as nails, screws, washers, etc., with a sacrificial coating to prevent or retard corrosion. The processes by which such coatings are applied are many and varied, and include hot-dip galvanizing, mechanical deposition, electroplating, etc. Mechanical deposition processes more particularly, which in the context of this specification comprehend processes by which metallic particles are impacted against and thereby mechanically bonded to the surface of a metal substrate, such as, for instance, mechanical plating and mechanical galvanizing, have been known in one form or another for fifty years or more.

Broadly speaking, in conventional mechanical deposition processes, metal parts to be “plated”—i.e., to which a sacrificial layer is to be applied—are tumbled in a suitable rotating vessel, such as a mill or barrel, together with impact media and a ductile metal powder and, optionally, one or more substances designed to make the surface of the metal parts more amenable to deposition of the metal powder. Deposition of the sacrificial layer occurs through a process known as “cold welding”; that is, the impact energy of the impact media mechanically bonds the metal powder to the surface of the metal parts, as well as to itself, until a desired sacrificial layer thickness is achieved. An overview of the conventional form of the mechanical plating process may be found in Wynn et al., “Mechanical Plating,” Products Finishing, pp 74-79 (October 2001), the disclosure of which is incorporated herein by reference in its entirety.

The impact media used today almost invariably is made of glass, and most typically comprises spherical glass beads, usually with dimensions of from 4 mesh up to approximately 100 mesh. Typically, the one or more optional substances include promoter compositions, including for instance an etching agent, such as an acid, to facilitate the deposition.

A number of plateable materials have previously been developed for use in mechanical deposition processes. These have included zinc, cadmium, tin, silver, copper, gold, zinc- cadmium mixtures, zinc-tin mixtures, and cadmium -tin mixtures, though cadmium is less favored today due to environmental concerns. Zinc is particularly commonplace as a sacrificial coating in conventional mechanical deposition processes. Tin is also commonly employed as it provides lubricity, a characteristic required on parts such as threaded fasteners, for instance screws and bolts.

Aluminum is also known as a sacrificial coating for metal parts and, as between coatings of aluminum and zinc of identical thickness, aluminum is known to provide superior corrosion protection. But while the deposition of aluminum on metal parts by hot-dip galvanizing and thermal spraying is relatively easily accomplished, mechanical deposition of aluminum is far more problematic.

Previously, efforts to mechanically deposit aluminum onto a metal substrate have yielded parts that are insufficiently corrosion-resistant, and at a plating efficiency that is unacceptably low; that is, the amount of pulverulent aluminum plated onto the metal substrate is low in relation to the amount of pulverulent aluminum initially provided.

There accordingly remains a need for a process of mechanically depositing a metal substrate with aluminum, to thereby yield a sacrificial coating having the corrosion-resistant benefits of aluminum, while improving the transfer efficiency achieved by prior art plating methods.

### SUMMARY OF THE DISCLOSURE

The specification describes a mechanical deposition process for depositing a metal powder on a metal substrate to form a sacrificial coating therefor, wherein the metal powder comprises a powder produced from a molecular alloy of zinc and aluminum, for instance by atomization of a molten alloy.

The method further comprises the steps of conducting the mechanical deposition process in the presence of a salt or oxide of a ductile metal more noble than zinc, an activating anion containing a fluoride moiety, and either a weak organic acid or a fluoride-engendering acidic compound.

According to a feature of one embodiment of the present invention, wherein the process is carried out in the presence of a weak organic acid, that weak organic acid is characterized by a dissociation constant of approximately 10⁻³ and, more particularly, is selected from the group consisting of citric acid, succinic acid, malic acid, and tartaric acid

According to a feature of a second embodiment of the instant invention, wherein the process is carried out in the presence of a fluoride-engendering acidic compound, that compound may be selected from the group consisting of hydrofluosilicic acid, fluoboric acid, and ammonium bifluoride.

According to another feature of this invention, the pulverulent metal powder comprises, by weight, from approximately 1% to approximately 25% of aluminum, and more particularly from approximately 5% to approximately 13% aluminum. The metal powder is further characterized by particulate sizes below approximately 40 microns, and more particularly below approximately 10 microns in diameter to obtain a smooth coating. The average diameter of the particles is desirably higher than 2 microns, since from 2 microns on zinc powders are known to become pyrophoric

According to a still further feature of this invention, the methodology thereof comprises the further step of providing an immersion copper deposit on the metal substrate prior to depositing the metal powder.

Per another feature, electroless tin is deposited on the immersion copper deposit.

Per yet another feature, the activating anion containing a fluoride moiety is selected from the group consisting of fluorides, fluoborates, silicofluorides, hexafluoantimonates, and hexafluorotitanates. The activating anion may, for example, comprise sodium silicofluoride.

According to still a further feature of the invention, the ductile metal salt or salt-engendering compound (e.g., oxide) is selected from the group consisting of stannous oxide and stannous sulfate.

### Written Description

The present invention generally comprises a process of mechanically depositing a sacrificial metal coating on a metallic substrate using a metal powder produced from a molecular alloy of zinc and aluminum, for instance by the atomization of a molten alloy of these metals. The process of this invention improves upon prior art methods for mechanically depositing aluminum-containing sacrificial coatings, providing a metal transfer efficiency, determined gravimetrically, of greater than 50%.

As used herein, the term “molecular alloy” means and refers to an intentional mixture of two or more metals at the molecular level; that is, the alloy is characterized as the admixture of two or more metals at the molecular level, in contrast to the mere admixture of two or more metal powders.

In the context of this specification, “transfer efficiency” means and refers to the percentage of pulverulent material input into the system—practically speaking, the amount of metal powder placed in the mill or other vessel—that is ultimately deposited on the metal substrate. According to the present disclosure, transfer efficiency so defined is determined gravimetrically. More specifically, this gravimetric determination is accomplished, in association with the illustrated examples, by weighing the metal parts both before and after the mechanical deposition process is carried out. The net weight gain for all plated parts is divided by the total original amount of pulverulent material, in like units, to yield a measure of the transfer efficiency.

The process of the present invention is best understood with reference to the below examples which, with exceptions as noted, were generally carried out according to the following methodology:

The parts to be plated were cleaned so as to be relatively free from oil and scale, all as known. The cleaned parts were thereafter loaded into a conventional mechanical plating barrel. Such barrels are typically rubber or plastic-lined, and are commonly hexagonal or octagonal in shape, although the particular plating barrel employed in the process of this invention is not intended as limiting. Impact media was also loaded into the plating barrel. The impact media used was, per convention, spherical glass beads of varying dimensions ranging from approximately 4 mesh to approximately 100 mesh. Roughly equal amounts, by volume, of impact media and parts to be plated were loaded into the plating barrel. However, this ratio of impact media to parts is variable according to such considerations as the weight of the parts to be plated or the thickness of the sacrificial coating to be applied, all as known to those of skill in the art. By way of non-limiting example, galvanizing a 2 mil thick coating commonly requires a 2 to 1 ratio of impact media to parts, respectively.

Next, water was introduced into the plating barrel and the level thereof adjusted appropriate to the parts to be plated, as is known. The barrel temperature was also adjusted as necessary, again according to known practices.

An acidic inhibited detergent cleanser was added to the plating barrel, and the barrel thereafter rotated until the parts were free from oxide, all as per conventional practice.

A copper salt was subsequently introduced into the plating barrel, the copper salt reacting with the ferrous substrate in the presence of a strong inhibited acid to produce a tightly adherent immersion copper coating on the parts. This copper coating served as a base for the subsequent mechanical deposition as described below.

A stannous (tin) salt or stannous oxide was next added to the plating barrel and allowed to dissolve to form stannous ions. Thereafter, a quantity of so-called “driving metal” powder was introduced to act as a reducing agent. As known, suitable “driving metals” include metals more active than tin. While aluminum can be employed as a driving metal, only divided zinc is most commonly employed In this methodology, zinc was used as the “driving metal,” and a thin deposit of tin formed on the surface of the metal parts. Along with the driving metal, dispersants, inhibitors, and surfactants were introduced into the plating barrel, per conventional practice.

### EXAMPLE 1

A small, oblique polypropylene plating barrel was charged (loaded) with 2000 cubic centimeters (cc) of glass impact media of the following dimensions and amounts: 50% at approximately 5mm diameter; 25% at approximately 10 to 13 mesh; 12½% at approximately 16 to 25 mesh; and 12½% at approximately 50 mesh. Thereafter, the plating barrel was “charged” (i.e., loaded) with the items to be plated as listed in Table 1.

TABLE I
Plated Parts

| Quantity | Description |
|---|---|
| 10 | 3-inch 10 d-type common nails |
| 10 | 2 inch 6 d-type common nails |
| 66 | washers, each with a 1 inch inner diameter, 1.5 inch |
| | outer diameter, and ¼ inch thickness |
| 10 | ⅜ inch plain-type washers |
| 5 | 2 inch by ⅜ inch machine screws |

To the foregoing was added 11 ml of inhibited acidic detergent cleaner, and the parts were tumbled in the plating barrel at approximately 25 rpm for 15 minutes. Thereafter, 1 gram of copper sulfate and 2 grams of salt were added to produce a bright immersion copper deposit.

Following creation of the immersion copper deposit, the parts were rinsed three times, and 3 grams of a promoter compound formulated as set forth in Table II, below, was introduced.

TABLE II

| | Amount By |
|---|---|
| Ingredient | Weight |
| Stannous Sulfate | 40% |
| Sodium Silicofluoride | 25% |
| Carbowax 20M | 6% |
| Citric Acid | 25% |
| Butyne 497 | 0.075% |
| Triphenylsulfonium Chloride | 0.075% |
| Dibenzyl Sulfoxide | 0.15% |
| Mannich Reaction Product R | 0.5% |
| Diatomaceous Earth | q.s. |
| | 100% |

The Mannich Reaction Product R of Table II is synthesized as follows: To 23.4 grams of dehydroabietyl amine (AMINE D, available from HERCULES CHEMICAL CO.) was slowly added 7.5 grams of acetophenone, with stirring; 10 grams of 20 Baume Hydrochloric (Muriatic) Acid was added slowly in the same manner. Next, 9.7 grams of 37% formaldehyde was added in small increments, and the mixture refluxed intermittently at 80 degrees Celsius over a period of three days. Thereafter, 25.0 grams of acetone was added directly and 9.5 grams of formaldehyde was added incrementally, continuing to reflux for an additional 24 hours. To the resultant crude product of this process was added 25 grams of isopropanol and 25 grams of nonionic polyoxyethylene adduct of nonylphenol (generically, NP-9).

Following introduction of the promoter compound, the barrel was tumbled for 1 minute, and then 1 gram of zinc was added and the barrel tumbled again for three minutes. Thereafter, the parts were flashed with a thin deposit of electroless tin.

In lieu of the promoter compound thus described, it is contemplated that the constituent materials thereof may be separately added directly to the plating barrel.

Subsequently, the following materials listed in Table III, below, were added to the plating barrel over a 14 minute period, divided into seven roughly equal portions.

TABLE III

| Ingredient | Amount | |
|---|---|---|
| Tin (Grade TF-101, available commercially | 2.67 | grams |
| from AcuPowder of Greenback, | | |
| Tennessee) | | |
| Zinc-Aluminum powder | 24.07 | grams |
| Promoter compound specified in Table II. | 3.5 | grams |

The zinc-aluminum powder of Table III, available commercially from UMICORE (Belgium), is a molecular alloy produced from the atomization of a molten alloy of zinc and aluminum This powder comprises about 13% aluminum and about 87% zinc, and is characterized by particles of below approximately 40 microns in diameter, and more particularly by particles of approximately 6 to 10 microns in diameter. The average diameter of the particles is desirably higher than 2 microns, since from 2 microns on zinc powders become pyrophoric. It is contemplated by this disclosure that the pulverulent metal may be formed from a molecular alloy of zinc and aluminum other than by the atomization of a molten alloy of these metals.

Following the addition of the foregoing, the plating barrel was tumbled for about ten minutes. The plated parts were thereafter removed from the plating barrel, separated from the media per known techniques, rinsed thoroughly, and dried in a small spin dryer

Upon inspection, the plated parts of this first example were found to have a uniform deposit of plated metal of approximately 0.001 inch thickness. Using the gravimetric analysis described hereinabove, it was determined that the transfer efficiency of the foregoing methodology was in excess of 95%. That is, approximately 95% of the pulverulent metal (i.e., the tin and zinc-aluminum of this example) added to the plating barrel was deposited on the parts

Subsequent evaluation of the thus plated parts was conducted by placing a number of the plated parts in a salt spray chamber of conventional construction, wherein the parts were exposed to a salt fog per ASTM B-117. These plated parts, having been subjected to no post-plating treatment, exhibited corrosion protection (i.e., the parts were characterized by a lack of formation of visually detectable base metal corrosion products) lasting in excess of 900 hours.

Still others of the thus-plated parts were, following plating as described, treated with a silicate solution, a known surface treatment for sacrificial coatings. After the silicate coating had dried, these plated parts were likewise placed in the salt spray chamber and exposed to a salt fog. These plated parts exhibited corrosion protection lasting in excess of 2000 hours.

Still others of the plated parts were placed in a Kestemich cabinet (DIN 50018) and “failed” (i.e., greater than 10% of the surface of the parts exhibited base metal corrosion products) only after 15 cycles.

### EXAMPLE 2 (COMPARATIVE)

Example 1 was repeated as described above, except that 26.74 grams of pure aluminum powder was substituted for the 2.67 grams of tin and 24.07 grams of zinc-aluminum powder of Example 1. The aluminum powder of this comparative example, commercially available from ALCAN TOYO (Grade 105), was characterized by particle dimensions of approximately 5 microns in diameter. Using the same gravimetric analysis, transfer efficiency was calculated to be 0%.

### EXAMPLE 3

Example 1 was repeated as described above, except that in place of the 24.07 grams of zinc-aluminum powder of that example there was substituted 24.07 grams of zinc-aluminum powder comprising approximately 9% aluminum (versus the approximately 13% aluminum of Example 1). Using gravimetric analysis, transfer efficiency was calculated to be approximately 72%.

### EXAMPLE 4

The method of Example 1 was repeated as described above, except that in place of the 24.07 grams of zinc-aluminum powder of that example there was substituted 24.07 grams of zinc-aluminum powder comprising approximately 5% aluminum (versus the approximately 13% aluminum of Example 1). Using gravimetric analysis, transfer efficiency was calculated to be approximately 80%.

### EXAMPLE 5 (COMPARATIVE)

The method of Example 1 was repeated as described above, except that in place of the 24.07 grams of zinc-aluminum powder of that example there was substituted 24.07 grams of zinc dust (Grade M515, available commercially from PURITY ZINC METALS, Mississauga, Ontario Canada). Surprisingly, in this example transfer efficiency was not as high as that achieved in Example 1.

### EXAMPLE 6 (COMPARATIVE)

The method of Example 1 was repeated as described above, except that in place of the 24.07 grams of zinc-aluminum powder of that example there was substituted 24.94 grams of zinc dust (Grade M515, available commercially from PURITY ZINC METALS, Mississauga, Ontario Canada) and 3.12 grams of aluminum powder (Grade 105, commercially available from ALCAN TOYO ). The aluminum powder of this example was characterized by particle dimensions of approximately 5 microns in diameter. Using gravimetric analysis, the transfer efficiency was calculated to be approximately 54%.

Analysis of the plated parts of this example evidenced the sacrificial coating to be only about 2% aluminum, with the balance comprising zinc and tin. Following plating, the glass impact media was contaminated with unplated pulverulent aluminum and zinc, being characterized by an extremely dark gray appearance.

While the overall transfer efficiency achieved by this example is not unacceptably low, the low percentage of aluminum plated highlights the overall inefficiencies associated with attempting to mechanically plate discrete metal powders.

### EXAMPLE 7

Example 1 was repeated, but in place of sodium silicofluoride there was substituted an equal amount of sodium hexafluozirconate. Using gravimetric analysis, transfer efficiency was calculated at approximately 42%.

### EXAMPLE 8

Example 1 was repeated, but in place of sodium silicofluoride there was substituted an equal amount of sodium hexafluoaluminate. Using gravimetric analysis, transfer efficiency was calculated at approximately 42%.

### EXAMPLE 9

Example 1 was repeated, but in place of sodium silicofluoride there was substituted an equal amount of sodium hexafluophosphate. Using gravimetric analysis, transfer efficiency was calculated at approximately 8%.

### EXAMPLE 10 (COMPARATIVE)

To the method of Example 1 there was substituted cadmium dust for the tin powder. Transfer efficiency was calculated to be approximately 29%, using gravimetric analysis. From the results of this and other examples cited herein, the inventor has concluded that cadmium has a negative impact on the plating process.

### EXAMPLE 11 (COMPARATIVE)

Example 1 was repeated, with the exception that no stannous sulfate was added to the plating barrel after the first addition of promoter. Using gravimetric analysis, transfer efficiency was calculated at approximately 13%.

### EXAMPLE 12

Example 1 was repeated, with the exceptions that no tin dust was employed, and that 26.74 grams of zinc-aluminum powder was used instead of the 24.07 grams of the prior example. Transfer efficiency, determined gravimetrically, was calculated to be approximately 92%.

### EXAMPLE 13 (COMPARATIVE)

A small, oblique polypropylene plating barrel was charged (loaded) with 2000 cubic centimeters (cc) of glass impact media of the following dimensions and amounts: 50% at approximately 5mm diameter; 25% at approximately 10 to 13 mesh; 12½ at approximately 16 to 25 mesh; and 12½% at approximately 50 mesh. Thereafter, the planning barrel was charged with the items to be plated as listed in Table IV, below:

TABLE IV
Plated Parts

| Quantity | Description |
|---|---|
| 10 | 3-inch 10 d-type common nails |
| 10 | 2 inch 6 d-type common nails |
| 66 | washers, each with a 1 inch inner diameter, 1.5 inch |
| | outer diameter, and ¼ inch thickness |
| 10 | ⅜ inch plain-type washers |
| 10 | M10 x 60 machine screws |
| 10 | Self-drilling, self-tapping type machine screws |
| 10 | 2 inch by ⅜ inch machine screws |

To the foregoing was added 15 ml of hydrochloric acid, I ml of nonylphenol ethoxylate, and 0.1 ml of Miranol JS and 0.01 ml of Propargyl Alcohol. The parts to be plated were thereafter tumbled for 15 minutes in the plating barrel.

Subsequently, 1 gram of copper chloride dihydrate was added to produce a bright immersion copper deposit on the parts.

Following creation of the copper deposit, 3 grams of a promoter compound formulated as set forth in Table V, below, was introduced.

TABLE V

| | Amount By |
|---|---|
| Ingredient | Weight |
| Stannous Oxide | 25% |
| Sodium Chloride | 25% |
| Sodium Silicofluoride | 6% |
| Carbowax 20M | 6% |
| Butyne 497 | 0.075% |
| Triphenylsulfonium Chloride | 0.075% |
| Dibenzyl Sulfoxide | 0.15% |
| Mannich Reaction Product R | 0.5% |
| Diatomaceous Earth | q.s. |
| | 100% |

The Mannich Reaction Product R of Table V was synthesized as specified above in connection with Example 1.

Subsequently, the following materials listed in Table VI, below, were added to the plating barrel over a 14 minute period, divided into seven roughly equal portions.

TABLE VI

| Ingredient | Amount | |
|---|---|---|
| Tin (Grade TF-101, available commercially | 2.67 | grams |
| from ACUPOWDER of Greenback, | | |
| Tennessee) | | |
| Zinc-Aluminum powder | 24.07 | grams |
| Promoter compound specified in Table V. | 3.5 | grams |

The zinc-aluminum powder of Table VI, available commercially from UMICORE (Belgium), is produced from the atomization of a molten alloy of zinc and aluminum. This powder comprises about 13% aluminum and about 87% zinc, and is characterized by particles of approximately 6 to 10 microns in diameter.

Following the addition of the foregoing, the plating barrel was tumbled for about 10 minutes. The plated parts were thereafter removed from the plating barrel, separated from the media per known techniques, rinsed thoroughly, and dried in a small spin dryer.

Using the gravimetric analysis described hereinabove, it was determined that the transfer efficiency of the foregoing methodology was about 41%.

### EXAMPLE 14

Example 13 was repeated, except that 40% fluoboric acid was substituted for the hydrochloric acid of that prior example. Transfer efficiency, determined gravimetrically, was calculated to be approximately 69%.

### EXAMPLE 15

Example 13 was repeated, except that hydrofluosilicic acid was substituted for the hydrochloric acid of that prior example. Transfer efficiency, determined gravimetrically, was calculated to be approximately 53%.

### EXAMPLE 16

Example 1 was repeated, substituting malic acid for the citric acid of that prior example. Transfer efficiency, determined gravimetrically, was calculated to be approximately 55%.

### EXAMPLE 17

Example 1 was repeated, substituting malonic acid for the citric acid of that prior example. Transfer efficiency, determined gravimetrically, was calculated to be approximately 45%.

### EXAMPLE 18

Example 1 was repeated, substituting tartaric acid for the citric acid of that prior example. Transfer efficiency, determined gravimetrically, was calculated to be approximately 59%.

### EXAMPLE 19 (COMPARATIVE)

Example 1 was repeated, substituting ethylenediamenetetraacefic acid (EDTA) for the citric acid of that prior example. Transfer efficiency, determined gravimetrically, was calculated to be approximately 41%.

### EXAMPLE 20 (COMPARATIVE)

Example 1 was repeated, except that the tinning step of that prior example was followed by the addition to the plating barrel of 5 grams of finely divided black iron oxide (Fe₃O₄), the chemical equivalent of the heat treat scale that is commonly removed from parts during the cleaning step. Using gravimetric analysis, the transfer efficiency of this example was calculated at approximately 30%.

### EXAMPLE 21 (COMPARATIVE)

Example 1 was repeated, except that the tinning step of that prior example was followed by the addition of 5 grams of finely divided 3 to 4 micron polyethylene-polytetrafluoroethylene (PTFE) wax powder, commercially available from MICRO POWDERS, Tarrytown, N.Y., under the name POLYFLUO, to the plating barrel. Using gravimetric analysis, the transfer efficiency of this example was calculated at approximately 30%, and the deposit was characterized by a slight lubricity.

### EXAMPLE 22 (COMPARATIVE)

A small, oblique, polypropylene plating barrel having approximately ⅓ ft³ working capacity was charged with 5ft² of oil-free 3d-type carbon steel finishing nails (3.6 lbs at 1.40 ft²/lb), and approximately 4 kg of glass impact media characterized by dimensions ranging from 0.01 to 0.2 inches in diameter. Water was added to the plating barrel in an amount sufficient to cover the nails and glass impact media The nails were cleaned and copper-flashed in accordance with the methodology set forth in Golben, U.S. Pat. No. 3,531,315, the disclosure of which is incorporated herein in its entirety.

Next was added to the plating barrel a solution of 0.64 grams of sodium sulfate, 6.4 grams of tin oxide (Stannous Oxide; SnO), 5.0 grams of ammonium bifluoride (NH₄HF₂), a corrosion inhibitor, and a dispersant. The plating barrel was then rotated for exactly two minutes to dissolve the foregoing ingredients. Subsequently, 25 grams of aluminum powder (Grade 105, commercially available from ALCAN TOYO) was added to the plating barrel, and the barrel was rotated for five minutes. Thereafter, 3 grams of copper sulfate (Copper Sulfate Pentahydrate; CuSO4-5H2O) was added to the plating barrel, which barrel was then rotated for 25 minutes. The nails were then removed from the plating barrel and rinsed with water. No metallic coating was observed in the nails, while the glass impact media was covered with unplated aluminum powder Using gravimetric analysis, the transfer efficiency was calculated to be 0%.

The nails of this example were subjected to a salt spray corrosion test (ASTM B 117), and within 24 hours were characterized by base-metal corrosion exceeding 10% of the surface area of the nails.

### EXAMPLE 23 (COMPARATIVE)

Example 1 was repeated, though without the rinsing step provided after the cleaning step of that earlier example, and further without the addition of citric acid in the continuation promoter. The transfer efficiency of this example, determined gravimetrically, was calculated approximately 13%.

### EXAMPLE 24

Example 1 was again repeated, with the following exceptions: The parts to be plated were limited to washers in order to evaluate the efficiency of the inventive process in relation to mil-square feet per pound of plating metal added. More specifically, the plating barrel was charged with 1009 grams of 3/8 inch washers with a surface area of 94.32 ft² per 100 lbs. The total square feet of washers in the plating barrel was thus 2.10 ft².

To the plating barrel was added the ingredients of Table VII, below, over a 14 minute period, divided into 7 roughly equal portions.

TABLE VII

| Ingredient | Amount | |
|---|---|---|
| Tin (Grade TF-101, available commercially | 1.33 | grams |
| from ACUPOWDER of Greenback, | | |
| Tennessee) | | |
| Zinc-Aluminum powder | 12.03 | grams |
| Promoter compound specified in Table V. | 1.75 | grams |

The Zinc-Aluminum powder of Table VII, available commercially from UMICORE (Belgium), is produced from the atomization of a molten alloy of zinc and aluminum. This powder comprises about 13% aluminum and about 87% zinc, and is characterized by particles of approximately 6 to 10 microns in diameter.

After plating, the thickness of the deposit was measured both by magnetic induction testing and with a micrometer. According to these known methods, the deposit thickness was determined to be, on average, approximately 0.74 mils. Accordingly, the inventor hereof has calculated that the process of this invention requires only approximately 0.19 pounds of metal per 100 ft 2 of surface area of parts to be plated in order to deposit each 0.0001 inch thickness of metal coating on such parts. This is to be contrasted with the results of conventional mechanical plating techniques using zinc and tin, according to which 0.4 pounds and 0.45 pounds of metal are required, respectively, in order to achieve comparable results.

### EXAMPLE 25 (COMPARATIVE)

Example 13 was repeated, except that in the promoter formulation an equimolar amount of sulfuric acid was substituted for hydrochloric acid, and sodium sulfate was substituted for sodium chloride. Per this example, transfer efficiency was calculated to be about 13%, using gravimetric analysis.

Of course, the foregoing is merely illustrative of the present invention; those of ordinary skill in the art will appreciate that many additions and modifications to the present invention, as set out in this disclosure, are possible without departing from the spirit and broader aspects of this invention as defined in the appended claims. For instance, while not cited by example herein, at least one other fluoride-engendering compound that may be employed in the methodology of this invention is ammonium bifluoride, while a further weak organic acid that may be employed is succinic acil

The invention in which an exclusive property or privilege is claimed is defined as follows:

1. A mechanical deposition process for depositing a metal powder on a metal substrate to form a sacrificial coating therefor, comprising the steps of conducting said mechanical deposition process in the presence of a fluoride-engendering acidic compound, a salt or oxide of a ductile metal more noble than zinc, and an activating anion containing a fluoride moiety, and wherein further said metal powder is produced from a molecular alloy of zinc and aluminum.

2. The mechanical deposition process of claim 1, wherein said metal powder is characterized by particulate sizes below approximately 10 microns in diameter.

3. The mechanical deposition process of claim 2, wherein said metal powder comprises, by weight, from approximately 5% to approximately 13% aluminum.

4. The mechanical deposition process of claim I, wherein said metal powder is produced by the atomization of a molten alloy of zinc and aluminum.

5. The mechanical deposition process of claim 1, comprising the further step of providing an immersion copper deposit on the metal substrate prior to depositing the metal powder.

6. The mechanical deposition process of claim 5, comprising the further step of depositing electroless tin on the immersion copper deposit.

7. The mechanical deposition process of claim 1, wherein the fluoride-engendering acidic compound is selected from the group consisting of hydrofluosilicic acid, fluoboric acid, and ammonium bifluoride.

8. The mechanical deposition process of claim 1, wherein the activating anion containing a fluoride moiety is selected from the group consisting of fluorides, fluoborates, silicofluorides, hexafluoantimonates, and hexafluorotitanates.

9. The mechanical deposition process of claim 1, wherein the activating anion containing a fluoride moiety is sodium silicofluoride.

10. The mechanical deposition process of claim 1, wherein the ductile metal salt or oxide is selected from the group consisting of stannous oxides and stannous sulfates.

11. A mechanical deposition process for depositing a metal powder on a metal substrate to form a sacrificial coating therefor, comprising the steps of conducting said mechanical deposition process in the presence of a weak organic acid, a salt or oxide of a ductile metal more noble than zinc, and an activating anion containing a fluoride moiety, and wherein further said metal powder is produced from a molecular alloy of zinc and aluminum.

12. The mechanical deposition process of claim 11, wherein said metal powder is characterized by particulate sizes below approximately 10 microns in diameter.

13. The mechanical deposition process of claim 12, wherein said metal powder comprises, by weight, from approximately 5% to approximately 13% aluminum.

14. The mechanical deposition process of claim 11, wherein said metal powder is produced by the atomization of a molten alloy of zinc and aluminum.

15. The mechanical deposition process of claim 11, comprising the further step of providing an immersion copper deposit on the metal substrate prior to depositing the metal powder.

16. The mechanical deposition process of claim 15, comprising the further step of depositing electroless tin on the immersion copper deposit.

17. The mechanical deposition process of claim 11, wherein said weak organic acid is characterized by a dissociation constant of approximately 10⁻³.

18. The mechanical deposition process of claim 17, wherein the weak organic acid is selected from the group consisting of citric acid, succinic acid, malic acid, and tartaric acid.

19. The mechanical deposition process of claim 11, wherein the activating anion containing a fluoride moiety is selected from the group consisting of fluorides, fluoborates, silicofluorides, hexafluoantimonates, and hexafluorotitanates.

20. The mechanical deposition process of claim 11, wherein the activating anion containing a fluoride moiety is sodium silicofluoride.

21. The mechanical deposition process of claim 11, wherein the ductile metal is selected from the group consisting of stannous oxides and stannous sulfates.

22. A mechanical deposition process, comprising the step of depositing a metal powder on a metal substrate to form a sacrificial coating therefor, wherein said metal powder comprises a powder produced from the atomization of a molten molecular alloy of zinc and aluminum.

23. The mechanical deposition process of claim 22, further comprising the steps of conducting said mechanical deposition process in the presence of a salt or oxide of a ductile metal more noble than zinc, a fluoride-engendering acidic compound, and an activating anion containing a fluoride moiety

24. The mechanical deposition process of claim 23, wherein the fluoride-engendering acidic compound is selected from the group consisting of hydrofluosilicic acid, fluoboric acid, and ammonium bifluoride.

25. The mechanical deposition process of claim 23, wherein the activating anion containing a fluoride moiety is selected from the group consisting of fluorides, fluoborates, silicofluorides, hexafluoantimonates, and hexafluorotitanates.

26. The mechanical deposition process of claim 23, wherein the activating anion containing a fluoride moiety is sodium silicofluoride.

27. The mechanical deposition process of claim 23, wherein the ductile metal is selected from the group consisting of stannous oxides and stannous sulfates.

28. The mechanical deposition process of claim 23, comprising the further step of providing an immersion copper deposit on the metal substrate prior to depositing the pulverulent metal powder.

29. The mechanical deposition process of claim 28, comprising the further step of depositing electroless tin on the immersion copper deposit.

30. The mechanical deposition process of claim 22, further comprising the steps of conducting said mechanical deposition process in the presence of a weak organic acid, a salt or oxide of a ductile metal more noble than zinc, and an activating anion containing a fluoride moiety.

31. The mechanical deposition process of claim 30, wherein said weak organic acid is characterized by a dissociation constant of approximately 10⁻.

32. The mechanical deposition process of claim 31, wherein said weak organic acid is selected from the group consisting of citric acid, succinic acid, malic acid, and tartaric acid.

33. The mechanical deposition process of claim 30, wherein the activating anion containing a fluoride moiety is selected from the group consisting of fluorides, fluoborates, silicofluorides, hexafluoantimonates, and hexafluorotitanates.

34. The mechanical deposition process of claim 30, wherein the activating anion containing a fluoride moiety is sodium silicofluoride.

35. The mechanical deposition process of claim 30, wherein the ductile metal is selected from the group consisting of stannous oxides and stannous sulfates.

36. The mechanical deposition process of claim 30, comprising the further step of providing an immersion copper deposit on the metal substrate prior to depositing the metal powder.

37. The mechanical deposition process of claim 36, comprising the further step of depositing electroless tin on the immersion copper deposit.

38. A mechanical deposition process for depositing a metal powder on a metal substrate to form a sacrificial coating therefor, comprising the steps of:
conducting said mechanical deposition process in the presence of a fluoride-engendering acidic compound, a ductile metal more noble than zinc, and an activating anion containing a fluoride moiety;
wherein said fluoride-engendering acidic compound is selected from the group consisting of hydrofluosilicic acid, fluoboric acid, and ammonium bifluoride;
wherein said ductile metal more noble than zinc is selected from the group consisting of stannous oxides and stannous sulfates;
wherein said activating anion containing a fluoride moiety is selected from the group consisting of fluorides, fluoborates, silicofluorides, hexafluoantimonates, and hexafluorotitanates; and
wherein further said metal powder comprises a powder produced from the atomization of a molten molecular alloy of zinc and aluminum.

39. The mechanical deposition process of claim 38, comprising the further step of providing an immersion copper deposit on the metal substrate prior to depositing the metal powder.

40. The mechanical deposition process of claim 39, comprising the further step of depositing electroless tin on the immersion copper deposit.

41. A mechanical deposition process for depositing a metal powder on a metal substrate to form a sacrificial coating therefor, comprising the steps of:
conducting said mechanical deposition process in the presence of a weak organic acid, a salt or oxide of a ductile metal more noble than zinc, and an activating anion containing a fluoride moiety;
wherein said weak organic acid is selected from the group consisting of acid is selected from the group consisting of citric acid, succinic acid, malic acid, and tartaric acid;
wherein said ductile metal more noble than zinc is selected from the group consisting of stannous oxides and stannous sulfates;
wherein said activating anion containing a fluoride moiety is selected from the group consisting of fluorides, fluoborates, silicofluorides, hexafluoantimonates, and hexafluorotitanates; and
wherein further said metal powder comprises a powder produced from the atomization of a molten molecular alloy of zinc and aluminum.

42. The mechanical deposition process of claim 41, comprising the further step of providing an immersion copper deposit on the metal substrate prior to depositing the pulverulent metal powder.

43. The mechanical deposition process of claim 42, comprising the further step of depositing electroless tin on the immersion copper deposit.
